(19) United States
(12) Patent Application Publication
(10) Pub. No.: US 2024/0054329 A1
(43) Pub. Date: Feb. 15, 2024

(54) SYSTEMS AND METHODS FOR A BAYESIAN SPATIOTEMPORAL GRAPH TRANSFORMER NETWORK FOR MULTI-AIRCRAFT TRAJECTORY PREDICTION

(71) Applicant: Yongming Liu, Chandler, AZ (US)

(72) Inventor: Yongming Liu, Chandler, AZ (US)

(73) Assignee: Arizona Board of Regents on behalf of Arizona State University, Tempe, AZ (US)

(21) Appl. No.: 18/234,124

(22) Filed: Aug. 15, 2023

Related U.S. Application Data
(60) Provisional application No. 63/371,466, filed on Aug. 15, 2022.

(51) Int. Cl. G06N 3/047; G06N 3/0455; G06N 3/049

(52) U.S. Cl. CPC G06N 3/047; G06N 3/0455; G06N 3/049

(57) ABSTRACT

A system includes a Bayesian Spatiotemporal Graph Transformer (B-STAR) architecture that models spatial and temporal relationship of multiple agents under uncertainties. The system enables Multi-Agent Trajectory Prediction for safety-critical engineering applications, (e.g., autonomous driving and flight systems) and considers the impact of various sources, such as environmental conditions, pilot/controller behaviors, and potential conflicts with nearby aircraft. It is shown that B-STAR achieves state-of-the-art performance on the ETH/UCY pedestrian dataset with UQ competence.

### CROSS-REFERENCE TO RELATED APPLICATIONS

This is a U.S. Non-Provisional Patent Application that claims benefit to U.S. Provisional Patent Application Ser. No. 63/371,466 filed 15 Aug. 2022, which is herein incorporated by reference in its entirety.

### GOVERNMENT SUPPORT

This invention was made with government support under NNX17AJ86 awarded by the National Aeronautics and Space Administration. The government has certain rights in the invention.

### FIELD

The present disclosure generally relates to air traffic control systems, and in particular, to a system and associated method for predicting trajectories of multiple aircraft simultaneously using a Bayesian spatiotemporal graph transformer network.

### BACKGROUND

The escalation of civil aviation operations leads to the concept of the next-generation air traffic management system (NextGen), which aims to efficiently and safely accommodate the growing air traffic flow within the United States airspace. In 2020, FAA reported the statistical analysis results of U.S. air traffic operations before the COVID-19 pandemic. It shows that the aviation operations handled by the core 30 airports increased by 1.8% annually. Moreover, the pilot certificates issued annually are also surging. Nonetheless, the total headcount of air traffic controllers is decreasing from 2018 to 2019. It has been shown that Air Traffic Controller (ATC) workload is one of the main limitations to the capacity of the current Air Traffic Management (ATM) system.

It is with these observations in mind, among others, that various aspects of the present disclosure were conceived and developed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-1D are a series of simplified diagrams showing a system for multi-vehicle trajectory prediction using a Bayesian spatiotemporal graph transformer network;

FIG. 2 is a diagram showing a batch of filtered ASDE-X data to show the pattern of aviation operations in a city environment;

FIG. 3 is a diagram showing a pipeline for implementing aspects of the system of FIGS. 1A-1D,

FIG. 4 is a diagram showing visualization of a sample testing case in Bokeh for the system of FIGS. 1A-1D,

FIGS. 5A-5D are a series of graphical representations showing visualization of B-STAR trajectory predictions for four test samples for the system of FIGS. 1A-1D,

FIGS. 6A-6H are a series of graphical representations showing uncertainties for trajectory prediction for the system of FIGS. 1A-1D,

FIGS. 7A and 7B are a pair of graphical representations showing sensitivity study results for the system of FIGS. 1A-1D,

FIG. 8 is a process flow chart showing an example method for trajectory prediction according to the system of FIGS. 1A-1D, and

FIG. 9 is a simplified diagram showing an example computing system for implementation of the system of FIGS. 1A-1D.

Corresponding reference characters indicate corresponding elements among the view of the drawings. The headings used in the figures do not limit the scope of the claims.

### DETAILED DESCRIPTION

The present disclosure focuses on modeling multi-aircraft social awareness in the real world and provides a system for multi-agent trajectory prediction model for aircraft with uncertainty quantification capabilities. The system infers uncertainties from variations within flight track data instead of pre-defined parameters or randomized inputs in other probabilistic frameworks. The present disclosure provides a demonstration of the efficacy of the system using terminal flight track data near one of the busiest airports (Class B Airspace) in the 30 major hubs.

### 1. Introduction

This ATC workload increase urges the advancement of air traffic decision-support tools (DSTs) of NextGen, which includes flight plan (FP) change, dynamic weather rerouting (DWR), trajectory prediction (TP), and conflict detection and resolution (CDR). Furthermore, in NextGen, surveillance information sharing is greatly enhanced among the controllers and the pilots. In such a way, the aircraft itself can take over a portion of ATM tasks from ground air traffic controllers. And this leads to the prediction of multi-aircraft trajectories, which is beneficial in the relevantly congested, near-terminal air space.

In practice, a deterministic TP model is insufficient when dealing with increasingly congested airspace and is not suitable for safety-related applications due to the inability to consider the uncertainty. The uncertainty comes from a variety of sources. The environmental factor is one of the major contributors to the TP uncertainty, which usually develops expeditiously and randomly. Human factors such as the pilot's intent or decision preference when dealing with an aviation event also contribute to the TP uncertainty. Other factors such as aircraft performance and the pilot's physical condition can lead to an unreliable deterministic model prediction.

The development of TP models is of fundamental importance to various advanced engineering application domains, e.g., autonomous systems and warning systems in the automotive and defense industry. Although most of the literature focuses on building TP models for a single agent, the multi-agent TP problem can be more challenging and practical in the real world. Challenges include (a) difficulty in capturing agent-to-agent interactions in a dynamic environment (e.g., two agents can have interactions in the current timestamps but no interactions in the future); (b) the action space for multiple agents are significantly larger than the single-agent case (e.g., at each step, the action of one agent has an impact on the actions to its neighboring agents); (c) the temporal correlations are coupled with spatial interactions (e.g., the time-series motions of the current agent need to consider the motions of all the neighbors).

A few classical data-driven multi-agent TP models capture multi-agent interactions by energy functions, which require significant feature engineering for application to a real case. The advancement of deep neural networks has demonstrated promising performance on a few pedestrian data benchmarks. The core idea behind these models is to capture the motion of each agent by the hidden space tensor and merge/share the hidden space across multiple agents. Social pooling is a widely used technique to equally combine the hidden space of each agent by the pooling mechanism. The attention mechanism weighs each agent using a learned score function, which treats each agent unequally. Transformer adopts the efficient yet straightforward self-attention mechanism to improve the temporal modeling than the previous literature. Recently, a Spatiotemporal Graph Transformer network (STAR) has been developed that shows state-of-the-art performance on the commonly used pedestrian dataset. This work interleaves the spatial and temporal correlations by a separate spatial transformer and temporal transformer. The spatial transformer adopts transformer-based graph convolution (TGConv) to extract the spatial interactions. The temporal transformer is a classical Transformer with multi-head attention for each pedestrian. The experiment shows that STAR achieves state-of-the-art performance on the ETH/UCY pedestrian benchmark dataset, however STAR has limited capability in quantifying the presence of uncertainties in multi-aircraft interactions in low-altitude near-terminal areas.

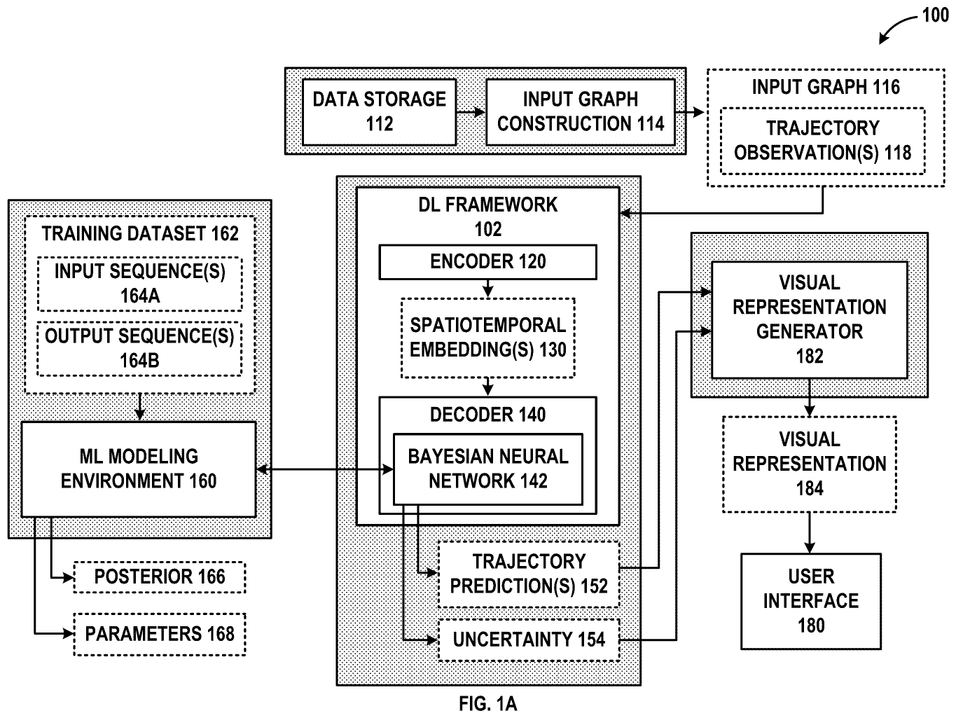

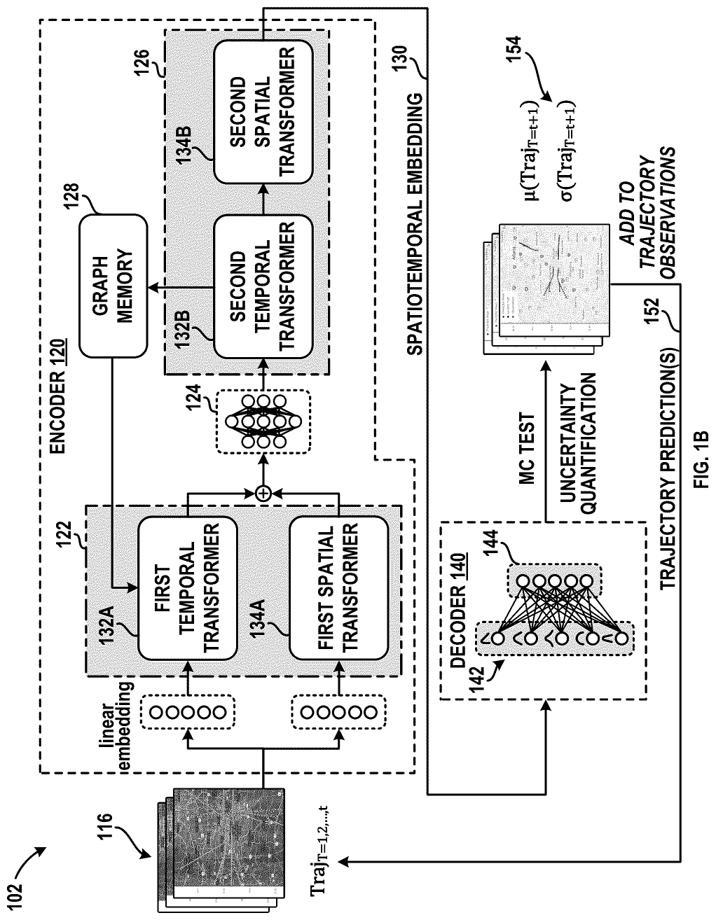

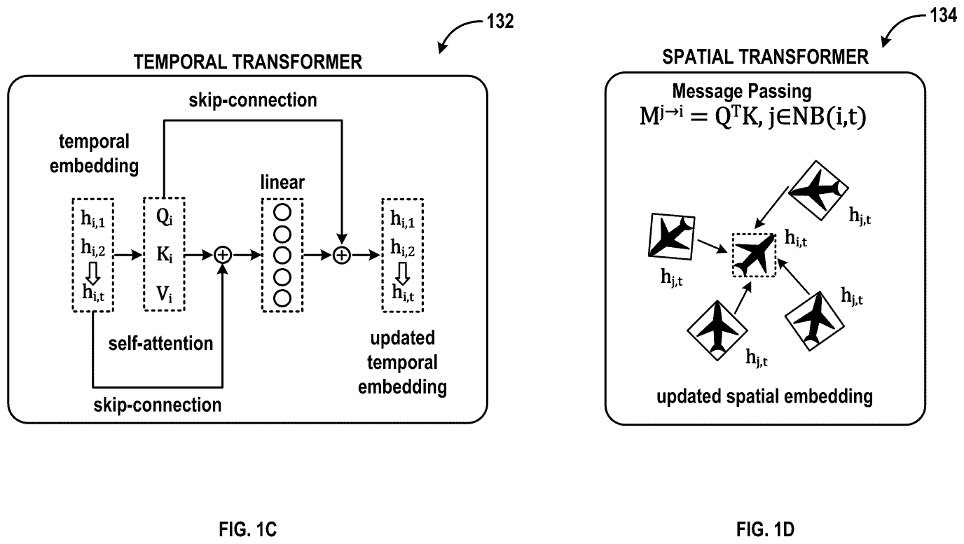

Referring to FIG. 1A, the present disclosure outlines a predictive system (hereinafter, system 100) that captures multi-aircraft interactions in low-altitude near-terminal areas to predict aircraft trajectories. The system 100 improves upon a Spatiotemporal Graph Transformer network (STAR) by incorporating Bayesian deep learning to achieve more accurate uncertainty quantification (UQ) in safety-critical air transportation systems. The system 100 is also referred to herein as Bayesian Spatiotemporal Graph Transformer network (B-STAR) for uncertainty-aware multi-aircraft trajectory prediction in the near-terminal airspace. Like pedestrian TP, the system 100 models the near-terminal aircraft as a graph and leverages the spatiotemporal correlation by interleaving a graph-based spatial Transformer module and a temporal Transformer. While the aviation domain typically focuses on operation safety and regulations (e.g., separation assurance), the system 100 addresses this domain-specific knowledge by a deep-learning framework 102 that quantifies uncertainty using Bayesian formulation to generate multi-aircraft trajectory predictions, with air traffic rules encoded into the deep learning model. Uncertainty quantification predictions of the system 100 are derived directly from variations present within input data and are solved by variational approximations with Gaussian priors over parameters of the deep-learning framework 102. Performance evaluation is presented with the UCY/ETH benchmark pedestrian dataset to validate prediction accuracy.

The system 100 implements a machine learning (ML) problem-solving pipeline that generates near-terminal multi-aircraft trajectory predictions using data from an Airport Surface Detection System-Model X (ASDE-X). System 100 includes a large-scale flight data querying module, a graph transformer-based prediction module, and a web-based interactive visualization module.

In the past, graph-based spatiotemporal prediction models have been applied to engineering problems, such as power grid performance prediction and traffic volume forecasting. However, it is believed that the system 100 is the first work that adapts a graph-based deep learning model for interactive multi-aircraft trajectory prediction.

Previous studies focused on a single aircraft trajectory prediction method, where a TP framework under convective weather conditions was proposed in the en-route phase. In the system 100 of the present disclosure, the focus is on modeling the impact of near-terminal multiple aircraft interactions. Near-terminal multiple aircraft interactions can be complex and involve inherent uncertainties associated with not only weather but other factors including airport terminal layout, pathing, scheduling, human behavior, and machine behavior. Real-world flight recording data is used to demonstrate and validate the system 100 for multi-aircraft interactions in the near-terminal area. The system 100 refines recent advancements in deep predictive modeling and adapts deep predictive modeling to the air transportation domain by encoding aviation regulations and physics knowledge into the deep learning model. Selected contributions of the present disclosure are listed below.
The system 100 implements a multi-agent trajectory prediction model with uncertainty quantification capabilities by a deep neural network framework referred to herein as “B-STAR”. The deep neural network framework infers uncertainties from variations within the flight track data instead of pre-defined parameters or randomized inputs as are common in other probabilistic frameworks.
Encoding the aviation regulations on the aeronautical separation into B-STAR. This is achieved by estimating the Haversine distance when selecting silent neighbors of the current object to build the graph encoding. Additionally, this disclosure includes results of a sensitivity study on separation assurance distance to see the impact to the proposed framework.
The system 100 implements a module-based machine learning framework utilizing advanced computer software and hardware tools for data analysis. Open-source toolsets for data pre-processing and web-based interactive visualization are made available and integrated with the B-STAR algorithm.

The rest of this disclosure is organized as follows. First, Section 2 reviews studies performed in the general field of trajectory prediction (TP), with a specific emphasis on air transportation. The development of various advanced data-driven TP models and necessary background knowledge are discussed in detail. Section 3 introduces the problem setup and the module-based multi-agent trajectory prediction framework implemented by the system 100. In Section 4, the experimental results are discussed in two parts. The present disclosure first shows that B-STAR achieves state-of-the-art with comparison to various recent advancements in multi-agents TP. Then the present disclosure shows testing results for the multi-aircraft trajectory prediction task with processed ASDE-X data. A discussion on limitations and future directions of the system is described in Section 5. Section 6 discusses the limitations and potential future research directions.

### 2. Literature Review

This section reviews the research on TP across different domains, with an emphasis on air traffic trajectory prediction. Then, the present disclosure introduces the necessary concepts required. This includes Transformer and Self-Attention, Graph Neural Networks, and Bayesian Deep Learning.

### 2.1 Related Works

### 2.1.1. Overview of Trajectory Prediction

Trajectory prediction is a critical functional component for the research focusing on different objects such as pedestrians, ground vehicles, aircraft, spacecraft, and rockets. Model-based methods are widely adopted in rigorous controlled, data expensive environments (e.g., spacecraft and rockets), while data-driven models are more popular for less-controlled, data-intensive circumstances (e.g., ground vehicles, pedestrians, and civil aircraft). Model-based methods typically predict the control parameters in the differential kinematic equations, where the control parameters can be used to describe the motion state of the target. Due to the limitation of available data, the data-driven approach in these areas adopts state-space estimations or intent inference methods to compensate for the learning models. On the other hand, TP in data-intensive circumstances acquires data-driven methods or a combination of data-driven and model-based methods. Researchers have proposed numerous advanced data-driven models, such as classical deep neural networks and graph-based deep neural networks with attention. The ground vehicle TP mainly focuses on predicting the behaviors of vehicles, pedestrians, and environments based on the observations, where the decentralized communication between each agent is critically important. Additionally, a hybrid approach combining data-driven methods with model-based methods is commonly adopted. Other researchers propose to analyze the trajectory patterns (e.g., trajectory similarities) on the macro-scale for a high-level prediction of trajectories.

### 2.1.2. Trajectory Prediction in Air Transportation

Trajectory prediction for aircraft has been long regarded as a major topic in air transportation research. As a result, researchers have developed extensive TP frameworks but with assumptions on different impact factors, in both deterministic and probabilistic senses. This includes TP with voice communication between the pilot and the tower, convective weather and other weather-related factors, human factors such as pilot/aircraft intent, and aircraft conditions.

The air transportation society has witnessed a significant increase in data-driven TP solutions in the last decade, associated with the advancement of machine learning techniques. The commonly used models are Kalman filtering, state-space model, simple neural network, Hidden Markov model, generalized linear regression, recurrent neural network (RNN), and generative adversarial network (GAN). Despite the aforementioned individual aircraft TP methods, there are very few works on multi-aircraft TP. A recent work using Social-Long Short-Term Memory (Social-LSTM) network was proposed for multi-aircraft trajectory prediction, where the social pooling layer learns interactions. One limitation of this method is that it treats aircraft within certain airspace equally, which does not follow the aeronautical separation standards. For example, in FAA Order 7110.65, different separation distances (from 3 NM to 10 NM) are allowed for different cases. In such cases, a dynamic determination of neighboring aircraft is preferred.

### 2.1.3. Multi-Agent Interactive Trajectory Prediction

The research on interactive trajectory prediction is primarily within the human pedestrian context. Existing methods can be divided into classical methods and deep learning-based methods.

Classical methods (e.g., Social Force models, Geometry-based methods) require hand-crafted features to capture crowd behaviors. They are less data-intensive with increased interpretability. Social Force models (guided by virtual repulsive and attractive forces) are built upon the assumption that pedestrians are mission-driven for destination navigation and collision avoidance. However, Social Force models perform poorly on TP tasks. Geometry-based models adopt optimization-based interactive TP with the geometry of each agent. Classical methods require extensive feature engineering and are hard to generalize in different scenes.

Deep learning-based methods learn crowd behaviors directly from the data, which achieves automatic feature engineering. Recurrent neural networks have been applied to TP and show satisfactory performance. Behavior CNN captures crowd behaviors using CNN. RNN-based approaches learn the pedestrian dynamical behavior with their latent state but generally perform poorly on complex temporal scenes. Social-pooling layers merge the latent space between several nearby pedestrians, leading to a socially aware prediction. The attention mechanism weighs each pedestrian with individual pedestrian importance through a learned function. In these works, the attention mechanisms are very simple with unsatisfied TP performance. More complex attention mechanisms, such as Transformer with self-attention, show effectiveness in modeling temporal dependencies. Furthermore, the multi-head attention mechanism jointly learns multiple hypotheses from different positional embedding representations.

### 2.2. Preliminaries

### 2.2.1. Transformer and Self-Attention

The recurrent architecture of deep neural networks relies on the sequential encoding of inputs, which leads to computational inefficiency since the processing cannot be parallelized. To tackle this issue, the Transformer architecture can replace RNN recurrence with a multi-head self-attention mechanism, which incorporates a richer context compared to RNN recurrence. The self-attention mechanism captures the mapping between input and output and demonstrates a shorter training time due to parallelization and higher accuracy for the Machine Translation task. Transformer has become the state-of-the-art framework for natural language processing (NLP). Variants of Transformers have shown success in a wide variety of problems, such as OpenAI's Generative Pre-trained Transformers (GPTs), and Bidirectional Encoder Representations from Transformer (BERT) for language representations.

In a typical temporal Transformer, the embedding hₜ at t is pre-trained or is simply the output from the annotation functions. The self-attention of Transformers learns the query matrix Qₜ=f_{Q}(hₜ), the key matrix Kₜ=f_{K}(hₜ), and the value matrix Vₜ=f_{V}(hₜ). The attention at time t computes at

$$Attention ( Q , K , V ) = \frac{softmax ( {QK}^{T} )}{\sqrt{{d}_{k}}} V \qquad ( 1 )$$

where

$$\frac{1}{\sqrt{{d}_{k}}}$$

accounts for the numerical stability of attentions. In Eq. (1), the compatibility function ƒ(Q,K)=QK^{T} defines how the keys and queries are matched together. The choice of compatibility functions defines the relationship between K and Q. The commonly used dot-product function, ƒ(Q,K)=QK^{T} is called machine-learned attention. A similarity-based compatibility function replaces f(Q,K)=QK^{T} by f(Q,K)=sim(Q,K) called similarity attention, where the most relevant keys are the most similar to the query. f(Q,K)=f(Q) is called location-based attention, where the relevance is solely a function of the key's location, independently of its content. In Eq. (1), softmax is the distribution function. The choice of distribution function depends on what properties the model needs, for instance, probability scores or Boolean scores to enhance sparsity.

Decoupling attention recurrence into multiple matrices allows self-attention to handle complex temporal dependencies. Multi-head attention is simply embedding the output from multiple self-attentions. With n heads:

MultiAttention=fₕ([Attention(Q,V,K)])ᵢ₌₁ⁿ) (2)

where fₕ is simply a fully connected layer merging the output from n heads. Additional position encoding is also required. Finally, the Transformer outputs the embeddings by a linear layer with two skip connections.

### 2.2.2. Graph Neural Networks

Transformers are limited to non-structured data, e.g., linguistic languages. Graph neural networks (GNNs) are introduced to model complex social behaviors from the structured graph data with explicit message passing. A graph with vertices and edges is represented as G=(V,E), where the number of nodes N_{nodes}=|V| and the number of edges N_{edges}=|E|. The adjacency matrix A∈ [symbol] ^{N}^{_{nodes}}^{×N}^{_{nodes}}. The graph can be directed or undirected depending on whether the edges are directed from one node to another. The graph is considered a dynamic graph when the topology of the graph varies with time. Especially, the graphs in the system 100 are undirected dynamical graphs. Graph convolutional networks (GCN) convolve the input X using the derived compact form:

$$H = {\tilde{D}}^{- \frac{1}{2}} \tilde{A} {\tilde{D}}^{- \frac{1}{2}} X W \qquad ( 3 )$$

where Ã=A+I_{N}, \tilde{D}ᵢᵢ=ΣⱼÃᵢⱼ,X∈ [symbol] ^{N}^{^{nodes}}^{×N}^{^{input}} is the input matrix, W∈ [symbol] ^{N}^{^{input}}^{×N}^{^{output}} is the kernel parameters, and H∈ [symbol] ^{N}^{^{nodes}}^{×N}^{^{output}} is the updated graph embedding.

The attention mechanism has also been adopted on graphs where different neighbors are assigned different weights to alleviate noises and achieve better results. Graph Attention network (GAT) incorporates weighted message passing between nodes and multi-head attention to achieve state-of-the-art results on multiple domains. The recently-introduced STAR model performs spatiotemporal TP with merely a self-attention mechanism and also demonstrates state-of-the-art performance on the UCY/ETH dataset. A transformer-based graph convolution module (TGConv)advances GATs with a self-attention transformer. The spatial and temporal correlation is learned by simply interleaving the spatial transformer and the temporal transformer. Furthermore, STAR also introduces a read-writable graph memory module to smooth the predictions and enforce temporal consistency continuously. However, there is still room for improvement in generating appropriate predictions.

### 2.2.3. Bayesian Deep Learning

Bayesian Deep Learning (BDL) is a widely explored area of research on quantifying the uncertainty and improving the robustness of deep learning models. The idea behind BDL is to place probability distributions over neural network parameters. For a regression problem, given an input sequence X={x₁, . . . , xₙ} and the corresponding output sequence Y={y₁, . . . , yₙ}, it is necessary to try to estimate neural network parameters ω for the approximation function y=f^{ω}(x). That is, to inference p(ω|X,Y). During the test phase, if there exists an observation data sequence x*, the prediction sequence y* can be considered a weighted average of a Bayesian neural network model where weights of the Bayesian neural network model are determined by the posterior probability distribution of ω, which can be mathematically represented as [symbol] _{p(ω|X,Y)}[p(y*|x*, ω)]. Unfortunately, this is intractable in any practical case. Consequently, Variational Inference (VI) can be introduced to approximate the posterior probability distribution of the parameters ω of the Bayesian neural network. In VI, it is necessary to find a best variational distribution approximation q_{θ}(ω) of p(ω|X,Y), where q_{θ}(ω)∈Q_{θ}(Ω), and Q_{θ}(Ω) is a family of i.i.d. Normal distributions,

Q_{θ}(Ω)˜ [symbol] (μ, diag(σ_{d}²)), (4)

and with mean-field assumption on each component of Q_{θ},

$${Q}_{Θ} = \{ q \vert {q}_{θ} ( ω ) = {\prod }_{i = 1}^{d} {q}_{θ i} ( {ω}_{i} ) \} . \qquad ( 5 )$$

Kullback-Leibler (KL) divergence can be used to measure the discrepancy between q_{θ}(ω) and p(ω|X,Y). That is, during training of the Bayesian neural network it is necessary to solve the optimization,

$${min}_{{q}_{θ} ∈ {Q}_{Θ}} [ {q}_{θ} ( ω ) ‖ p ( ω \vert X , Y ) ] . \qquad ( 6 )$$

This objective is equal to minimizing the objective function in Eq. (7), which is also known as variational free energy.

$${min}_{{q}_{θ} ∈ {Q}_{Θ}} ( {q}_{θ} ( ω ) ‖ p ( ω ) ) - {𝔼}_{{q}_{θ} ( ω )} [ log ( p ( Y \vert X , ω ) ) ] \approx \frac{1}{N} {\sum }_{i = 1}^{N} [ log ( {q}_{θ} ( {ω}_{i} ) ) - log ( p ( {ω}_{i} ) ) - log ( p ( Y \vert X , {ω}_{i} ) ) ] \qquad ( 7 )$$

From Eq. (7), it is shown that VI-based approximation can be used to infer parameters ω of a Bayesian neural network through the sampling of the three terms derived from the variational free energy. Various weight perturbation methods enable direct gradient-based optimization during VI. The recent advancement of probabilistic programming languages also established the pathway of building scalable real-world applications.

### 3. Methodologies

In this section, the setup for the problem that the system 100 aims to solve is outlined in Section 3.1. Then, section 3.2 introduces an architecture of a deep-learning framework 102 (e.g., B-STAR) of the system 100 that enables the system 100 to generate multi-aircraft trajectory predictions for future time steps based on input data of an input graph including flight trajectory data from previous time steps. The deep-learning framework 102 decomposes spatiotemporal attention learning into temporal modeling, spatial modeling, and uncertainty modeling, which will also be discussed in detail herein.

### 3.1 Problem Setup

The task that the present disclosure focuses on is time-series forecasting of trajectories for multiple aircraft. The system 100 aims to predict future trajectories (e.g., generate trajectory predictions) for a plurality of agents based on observed trajectories of the plurality of agents. A total quantity of timestamps of a sequence are denoted herein as size T for each individual agent (e.g., aircraft of a plurality of aircraft that are being tracked by the system 100. The first T_{obs} timestamps include observation data, and the remaining T−T_{obs} timestamps are the prediction horizon of the model of the system 100. A total number of agents that show up in a scene is denoted as N. pₜⁱ=(xₜⁱ, yₜⁱ) denotes the position of agents in a top-down view environment. An undirected edge for each aircraft pair with a distance less than a threshold ξ. This leads to the dynamical undirected graph G^{t}=(V^{t}, E^{t}) mentioned in previous sections. Similar setups have been used for pedestrian TP.

$${d}_{i j}^{t} = 2 \times R \times arcsin ( \sqrt{{sin}^{2} ( \frac{{y}_{t}^{i} - {y}_{t}^{j}}{2} ) ( + cos ( {y}_{t}^{i} ) cos ( {y}_{t}^{i} ) {sin}^{2} ( \frac{{x}_{t}^{i} - {x}_{t}^{j}}{2} )} ) \qquad ( 8 )$$

$$R = 6371 km$$

For the aircraft TP case, pₜⁱ=(xₜⁱ, yₜⁱ) denotes the position of aircraft pⁱ's location shows in the radar measurement. An input graph is built by calculating Haversine distance between two aircraft pairs (pₜⁱ, pₜⁱ) at the same timestamp with Eq. (8). Haversine distance represents great-circle distance between two World Geodetic System 1984 (WGS84) coordinates, and is used to encode aviation regulations on aeronautical separation when selecting “silent neighbors” of an aircraft to build graph encodings based on the input graph. If dᵢⱼ^{t} is greater than a neighboring threshold ξ, a connection Eᵢⱼ^{t} is established between aircraft i and aircraft j at timestamp t, and vice versa. This leads to the dynamical changing graph G^{t}=(V^{t},E^{t}) at each timestamp t, which includes all the aircraft pairs classified as neighbors. As such, the use of Haversine distance when building the input graph adapts the deep-learning framework 102 to the air transportation domain by encoding aviation regulations and physics information into the deep learning model during training.

Referring to FIG. 1A, the deep-learning framework 102 can access that or otherwise communicate with data storage 112 to construct (e.g., by an input graph construction module 114) or otherwise access an input graph 116 including trajectory observations 118 over T_{obs}. The input graph 116 can incorporate a Haversine distance between a first agent (e.g., a first aircraft) and a second agent (e.g., a second aircraft).

### 3.2 Bayesian Spatiotemporal Graph Transformer

With additional reference to FIGS. 1B-1D, in some embodiments the deep-learning framework 102 of the system 100 includes a stacked encoder-decoder structure, where an encoder 120 of the deep-learning framework 102 includes several Transformer building blocks to generate a spatiotemporal embedding 130 for the plurality of agents based on the input graph 116 by separately leveraging spatial modeling and temporal modeling. In addition, a decoder 140 of the deep-learning framework 102 accounts for uncertainty modeling using a Bayesian neural network 142 and generates trajectory predictions 152 as an output of the deep-learning framework 102. A deterministic encoder is kept from a Bayesian decoder to reduce computational complexity while retaining the performance of the entire framework. Importantly, the decoder 140 infers uncertainties 154 of trajectory predictions 152 based on variations within the observation data (e.g., flight tracking data) of the input graph 116 rather than by pre-defined parameters or randomized inputs which are commonly used in other probabilistic frameworks. The encoder-decoder structure of the deep-learning framework 102 of the system 100 is shown in FIGS. 1B-1D.

Transformer Encoder: The encoder 120 of the deep-learning framework 102 includes a temporal transformer 132 (FIG. 1C) for temporal modeling, and a spatial transformer 134 (FIG. 1D) for spatial modeling. The temporal transformer 132 considers every single agent independently from one another and learns dynamics of each agent from agent-specific data of the agent. In some examples, a temporal model of the temporal transformer 132 can be a standard temporal transformer neural network, which has been shown to achieve better time-series learning performance compared to RNNs. The spatial transformer 134 adopts TGConv to perform transformer-based graph convolution for spatial modeling.

In the example shown, the encoder 120 includes a parallel stage 122 having a first temporal transformer 132A and a first spatial transformer 134A that receive input data (e.g., input embeddings of the input graph 116) and collectively generate a preliminary spatiotemporal embedding. The encoder 120 includes a multilayer perceptron 124 at the outputs of the first temporal transformer 132A and the first spatial transformer 134A that combines a first updated temporal embedding produced by the first temporal transformer 132A with a first updated spatial embedding produced by the first spatial transformer 134A, which results in the preliminary spatiotemporal embedding of the input graph 116.

The parallel stage 122 is followed by a sequential stage 126 having a second temporal transformer 132B and a second spatial transformer 134B that receive the preliminary spatiotemporal embedding as input and collectively generate the spatiotemporal embedding 130. The sequential stage 126 can act act as post-processing blocks for concatenated feature embeddings, e.g., of the preliminary spatiotemporal embedding. The second temporal transformer 132B of the sequential stage 126 of the encoder 120 generates a second updated temporal embedding from the preliminary spatiotemporal embedding, and the second spatial transformer 134B receives the output of the second temporal transformer 132B and generates the spatiotemporal embedding 130. As shown, the encoder 120 can also include a graph memory 128 that applies the second updated temporal embedding to the first temporal transformer 132A of the parallel stage 122 of the encoder 120 and enables conditioning of current temporal embeddings of a current time step with respect to previous temporal embeddings of a previous time step.

Bayesian Decoder: The decoder 140 of the deep-learning framework 102 takes the spatiotemporal embeddings 130 (e.g., outputs of the sequential stage 126 of the encoder) as input and generates a trajectory prediction 152 for each agent (e.g., aircraft) represented in the input graph 116. Importantly, the decoder 140 includes the Bayesian neural network 142 including one or more stochastic Bayesian fully-connected layers for generating trajectory predictions 152 and quantifying uncertainty 154 associated with the trajectory predictions 152. Parameters ω of Bayesian layers of the Bayesian neural network 142 can be initialized with standard normal distribution and can be sampled during inference of a posterior probability distribution as discussed herein with respect to Eq. (7).

Further, a trajectory prediction 152 associated with a current or past timestep is added back to the set of trajectory observations 118 for trajectory predictions 152 associated with future timesteps. To improve long-horizon temporal consistency of the trajectory predictions 152 generated at the decoder 140, the graph memory 128 is used as discussed herein to allow the first temporal transformer 132A and/or the second temporal transformer 132B to condition temporal embeddings for a current timestep on temporal embeddings for previous timesteps. In such a way, the system 100 obtains consistent trajectory predictions and avoids unreasonable trajectory predictions. In some examples, the graph memory 128 is read-writable.

### 3.2.1. Temporal Modeling

Referring to FIGS. 1B and 1C, inputs to the first temporal transformer 132A of the parallel stage 122 of the encoder 120 include input embeddings from raw input data, which can be mathematically represented as {h₁ⁱ, h₂ⁱ, . . . , hₜⁱ}, for agent i (where an agent corresponds to an individual aircraft). Input embedding can be achieved from the input graph 116 using a linear layer at an input of the first temporal transformer 132A. The second temporal transformer 132B of the sequential stage 126 can be configured similarly, and takes an output of the multilayer perceptron 124 as input. The outputs of each temporal transformer 132 include an updated embedding sequence which can be mathematically represented by {ĥ₁ⁱ, ĥ₂ⁱ, . . . , ĥₜⁱ}. For agent i, each temporal transformer 132 first learns a query matrix represented by Qⁱ, Kⁱ, and Vⁱ as shown with respect to Eq. (9):

Qⁱ=f_{Q}({hₜⁱ}ₜ₌₁^{T}),Kⁱ=f_{K}({hₜⁱ}ₜ₌₁^{T}),Vⁱ=f_{V}({hₜⁱ}ₜ₌₁^{T}) (9)

where functions ƒ_{Q}, ƒ_{K}, and ƒ_{V} are shared across all agents represented within the input graph 116. Computing of attentions for the temporal transformers 132 follow a standard computation flow of the multi-head attention mechanism discussed herein with respect to Eqs. (1) and (2).

### 3.2.2. Spatial Modeling

The spatial transformers 134 of the encoder 120 each learn spatial embeddings that represent interactions between agents in a scene (e.g., agents/aircraft represented within the input graph 116) with TGConv. As mentioned, TGConv is a transformer-based graph convolution block that performs message passing between graph nodes. TGConv is an attention-based graph convolution block, with a different spatial embedding hⁱ updating computation procedure.

In TGConv, inputs include a spatial embedding set for multiple agents, which can be mathematically represented as {h¹, h², . . . , hⁱ}. A query vector for an agent i can be represented as qⁱ=f_{q}(hⁱ), a key vector can be represented as kⁱ=fₖ(hⁱ), and a value vector can be represented as vⁱ=fᵥ(hⁱ). The message passing from agent j to agent i can be mathematically represented as:

m^{j→i}=(qⁱ)^{T}k^{j}. (10)

The attention-based graph convolution in Eq. (1) can be reorganized into TGConv as:

$${Att}^{i} ( {Q}^{i} , {K}^{i} , {V}^{i} ) = {\frac{softmax ( {[ {m}^{j \to i} ]}_{j ∈ N B ( i ) ⋃ \{ i \}} )}{\sqrt{{d}_{k}}} [ {v}_{j} ]}_{j ∈ N B ( i ) ⋃ \{ i \}}^{T} + {h}^{i} , \qquad ( 11 )$$

where NB(i) represents a neighbors set of agent i. An updated spatial embedding ĥⁱ is calculated by Eq. (12) with skip connections before an output function ƒₒ:

ĥⁱ=fₒ(Attⁱ)+Attⁱ. (12)

Each spatial transformer 134 outputs an updated spatial embedding {hₜ¹, hₜ², . . . , hₜⁱ}, t∈{1, 2, . . . , T_{obs+1}} of the current agent i.

### 3.2.3. Combining Temporal and Spatial Modeling

The updated spatial embedding provided by the first spatial transformer 134A can be concatenated with the updated temporal embedding {ĥ₁ⁱ, ĥ₂ⁱ, . . . , ĥₜⁱ}, t∈{1, 2, . . . , T_{obs+1}} of agent i (e.g., which is an output of the first temporal transformer 132A). The multilayer perceptron 124 takes the concatenated combination of outputs from the first temporal transformer 132A and the first spatial transformer 134A as input, the output of which (e.g., a preliminary spatiotemporal embedding) is provided as input to the second temporal transformer 132B which can be structured similarly to the first temporal transformer 132A. The output of the second temporal transformer 132B is provided as input to the second spatial transformer 134B (which can be structured similarly to the first spatial transformer 134A), the output of which can be applied to the decoder 140. Also, the output of the second temporal transformer 132B is returned to the first temporal transformer 132A through the graph memory 128 to account for a consistent recursive temporal prediction.

### 3.2.4. Uncertainty Modeling

Uncertainty modeling for trajectory predictions 152 produced by the deep-learning framework 102 comes from a Bayesian neural network 142 of the decoder 140 having Bayesian linear layers. A stochastic Bayesian classifier can be selected as the Bayesian neural network 142 for uncertainty quantification. In the example shown, a Bayesian encoder is used as the Bayesian neural network 142. However, in other embodiments, the decoder 140 may also use probabilistic Bayesian input embeddings or probabilistic attentions. Finally, an output layer 144 of the decoder 140 can be deterministic to avoid training instability.

As shown in FIG. 1A, when training the Bayesian neural network 142 of the decoder 140, parameters ω of the Bayesian neural network 142 can be inferred by variational inference (section 2.2.3 herein). For training the Bayesian neural network 142, a machine learning modeling environment 160 of the system 100 determines parameters ω of an approximation function of the Bayesian neural network 142. This can be achieved by inferencing a probability of having values of parameters ω given an input sequence (input sequences 164A of a training dataset 162, which can include training spatiotemporal embeddings that correspond with spatiotemporal embeddings (e.g., spatiotemporal embeddings 130) that can be produced by the encoder 120) and a corresponding output sequence (output sequences 164B of the training dataset 162, which can include trajectory predictions for each agent represented within an input graph). The probability of having values of parameters ω can be represented by a posterior probability distribution (e.g., posterior 166) of parameters ω (e.g., parameters 168) of the Bayesian neural network. However, as discussed, direct sampling of parameters ω is intractable without additional techniques. Variational inference can be used to infer parameters) of the Bayesian neural network 142 of the decoder by sampling terms derived from variational free energy shown in Eq (7).

Outside of training, e.g., at the “test” phase, decoder 140 estimates prediction uncertainty through MC tests as in Eq. (13). Test data pairs can be mathematically represented with x* and y*, well-trained model parameters of the Bayesian neural network 142 can be mathematically represented with a, and a the number of tests performed can be mathematically represented with N. The system 100 also includes a visual representation generator 182 that can generate and display visual representations 184 of the trajectory predictions 152 at a user interface 180.

$$p ( {y}^{*} \vert {x}^{*} , X , Y ) = {𝔼}_{p ( ω \vert X , Y )} [ p ( {y}^{*} \vert {x}^{*} , ω ) ] \approx \frac{1}{N} {\sum }_{n = 1}^{K} p ( {y}^{*} \vert {x}^{*} , {\hat{ω}}_{k} ) \qquad ( 13 )$$

### 4. Experiments

Evaluation metrics used in the experiments are first discussed in Section 4.1. Results on ETH (ETH and HOTEL) and UCY (ZARA1, ZARA2, and UNIV) pedestrian TP dataset are reported in Section 4.2. ETH and UCY are human crowd datasets with a medium interaction density. They serve as the most used benchmark dataset for demonstrating state-of-the-art performances in multi-agent TP research. The present disclosure compares the system 100 to 8 state-of-the-art TP models developed on the pedestrian dataset with the same setup. The leave-one-out cross-validation strategy is used to get the test results. Lastly, an implementation of a module-based machine learning problem-solving pipeline for near-terminal multi-aircraft TP is reported, demonstrated with real-world radar recording data in Section 4.3. Additionally, a sensitivity study is performed on the aircraft case.

Briefly, the present disclosure shows that: (a) The uncertainty-aware deep learning framework of the system 100 can achieve state-of-the-art mean prediction performance on the ETH and UCY pedestrian datasets; (b) the deep-learning framework 102 of the system 100 gives reliable uncertainty estimates without sacrificing the prediction power; and (c) the sensitivity study shows a larger prediction-observation ratio leads to a declined test performance.

### 4.1. Evaluation Metrics

The standard way to evaluate performance for trajectory prediction models is to use the Average Displacement Error (ADE) and Final Displacement Error (FDE) as minimization objectives. A lower ADE and FDE represent better model performance on the given dataset. For training a model of the deep-learning framework 102 of the system 100, ADE and FDE are minimized with a training dataset (“training set”) and backpropagated to update parameters of the model of the deep-learning framework 102. After several epochs of training, a testing dataset (“test set”) is applied as input to the model of the deep-learning framework 102 and ADE and FDE are evaluated. The model of the deep-learning framework 102 that performs the best with respect to ADE and FDE on the test set is saved for implementation.
ADE: The averaged mean square error between the prediction and ground truth sequences.
FDE: The L₂ distance between the predicted final position and the ground truth final position.

### 4.2. Case I: Pedestrian Crowd TP

This case study is conducted as a baseline study to validate the performance of the deep-learning framework 102 (“B-STAR”) of the system 100, especially compared with existing ML models proposed in the literature. The same experiment setup is applied on the 5 scenarios from ETH/UCY dataset for a fair comparison. To keep this case study simple, recorded results from the literature are presented.

### 4.2.1. State-of-the-Art Models

The deep-learning framework 102 of the system 100 is compared with several state-of-the-art models as baselines. This includes:
Social LSTM: Each agent in the scenario is modeled with an LSTM, where the hidden states are shared between neighbors.
State Refined LSTM (SR-LSTM): Similar to S-LSTM, each agent is modeled with an LSTM but with a state refinement module on the hidden state tensors. The refinement module includes a motion gate and pedestrian attention functions to extract useful features of each pedestrian.
Social Attention: The crowd of pedestrians is modeled with a spatiotemporal graph and adopts two LSTMs to handle the spatial and temporal dependencies.
TrafficPredict: TP motion prediction model using LSTMs. This method introduces a category layer to refine the predictions of the agents belonging to the same type, (e.g., vehicles and pedestrians).
STAR: The interleaved spatial and temporal Transformers learn spatiotemporal features from graph structured data with TGConv.
Social GAN: The socially Pooling Module (PM) is adopted into the general adversarial network (GAN). The generator module G learns from the data and outputs the predicted trajectory. G is an encoder-decoder framework where the hidden states of the encoder are linked with the hidden states of the decoder via PM. The discriminator D tries to classify the ground truth and the predicted trajectory from G. Similar to the classical GAN, the randomness comes from the random input to the Generator.
Trajectron: A variational encoder-decoder structure for multi-agent TP. The encoder encodes the history and future states of a given node and predict the distribution of future trajectories using deep generative modeling. This paper also adopts the β-weight ELBO. The randomness comes from the random sampling of hidden variables.
STAR-Dropout: The original STAR model with dropout applied on fully connected layers. The randomness comes from the pre-defined dropout ratio.

### 4.2.2. Comparisons

Table 1 shows the comparison of the B-STAR model of the system 100 with the literature on pedestrian datasets. The system 100 is compared with 5 deterministic methods and 3 stochastic TP methods. Results show that the system 100 achieves state-of-art test performance on these scenarios, except for ETH and HOTEL. Then, the B-STAR model of the system 100 is applied to the air transportation problem.

TABLE 1
B-STAR Compared with state-of-the-art multi-agent TP models
on the ETH/UCY dataset

| | ETH | HOTEL | ZARA1 | ZARA2 | UNIV |
|---|---|---|---|---|---|
| Deterministic | | | | | |
| Social LSTM | 0.77/1.60 | 0.38/0.80 | 0.51/1.19 | 0.39/0.89 | 0.58/1.28 |
| SR-LSTM | 0.63/1.25 | 0.37/0.74 | 0.41/0.90 | 0.32/0.70 | 0.51/1.10 |
| Social Attention | 1.39/2.39 | 2.51/2.91 | 1.25/2.54 | 1.01/2.17 | 0.88/1.75 |
| TrafficPredict | 5.46/9.73 | 2.55/3.57 | 4.32/8.00 | 3.76/7.20 | 3.31/6.37 |
| STAR | 0.56/1.11 | 0.26/0.50 | 0.41/0.90 | 0.31/0.71 | 0.52/1.15 |
| Stochastic | | | | | |
| Social GAN | 0.81/1.52 | 0.72/1.61 | 0.34/0.69 | 0.42/0.84 | 0.60/1.26 |
| Trajectron | 0.65/1.12 | 0.35/0.66 | 0.34/0.69 | 0.29/0.60 | 0.52/1.10 |
| STAR-Dropout | 0.36/0.65 | 0.17/0.36 | 0.26/0.55 | 0.22/0.46 | 0.31/0.62 |
| B-STAR | 0.44/0.72 | 0.24/0.43 | 0.26/0.54 | 0.25/0.41 | 0.36/0.68 |

### 4.3. Case II: Near-Terminal Multi-Aircraft TP

In this section, implementation details for the near-terminal multi-aircraft TP as a module-based system are reported. As mentioned in Section 1, the system 100 implements a module-based ML problem-solving pipeline with a refined state-of-the-art multi-agent prediction model. Aspects of the system 100 are discussed herein, including a data processing module, a ML modeling environment, and a web-based interactive visualization module. The data used in this case is the ASDE-X near-terminal flight track surveillance recording of Hartsfield-Jackson Atlanta International Airport (KATL).

The classical leave-one-out cross-validation method is followed during the training and evaluation process. Furthermore, two sensitivity studies are performed to fully understand the prediction capability of the deep-learning framework 102.

### 4.3.1. ASDE-X Near-Terminal Flight Data

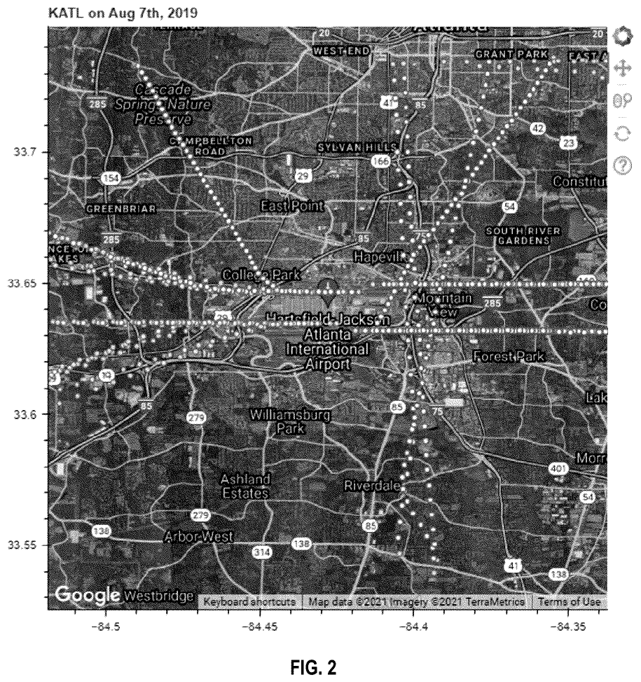

Raw data streams are obtained from the Sherlock Data Warehouse (SDW). SDW is a platform for reliable aviation data collection, archiving, processing, query, and delivery to support ATM research. The Sherlock data primarily comes from the FAA and the National Oceanic Atmospheric Administration (NOAA). This work, focuses on the specific problem of near-terminal multi-agent TP. Thus, only the near-terminal surveillance recordings are required, which is the data from the Airport Surface Detection System-Model X (ASDE-X) system. ASDE-X is a surveillance system using radar, multilateration, and satellite technology that allows air traffic controllers to track the surface movement of aircraft and vehicles. It is reported that KATL has the highest average daily capacity and average hourly capacity among the core 30 airports of the United States. Thus, data from one week's (Aug. 1, 2019 to Aug. 7, 2019) flight trajectory recordings from the ASDE-X of KATL, with the busiest operation period each day (2 pm to 10 pm), are used for demonstration of the system 100. The dataset has time interval Δt=1 s, and is down-sampled into Δt=5 s timestep. The data is filtered from a rectangular area (r=0.2° latitude/longitude) around KATL, with the accelerated geospatial query tool in GeoSpark. The first 6 days' data is used for training and validation, and the last day's data is kept for testing and performance visualization. A batch of the processed test dataset is visualized in FIG. 2.

The processing steps of the raw ASDE-X data from Sherlock can be summarized as follows:
(a) perform a time window filter to find the flight tracks within the desired time range on each day (in this work, the time range is from 2 pm to 10 pm locally);
(b) perform rectangular filter of the flight tracks within the area of interest, with the help of geometry large-scale data processing package (in this work, the range is 0.2° latitude by 0.2° longitude centered at the airport coordinates; also, filtering is applied along the altitude dimension to make sure the aircraft is above the ground level);
(c) anonymize the sensitive information in the ASDE-X dataset, (e.g., the real flight callsign, flight ID, and Unix timestamps);
(d) downsample the time-series to a user-defined forecasting time interval (in this case, Δt=5 s; this sampled data sparsity will determine the capability of a well-trained model, discussed in detail in Section 5).

Further pre-processing steps follow standard strategies. The origin of the input sequence is shifted to the last timestamp of observations. Also, the entire sequence has 20 timestamps for each aircraft. In this case, there are 12 timestamps as observations and 8 timestamps as predictions.

### 4.3.2. Module-Based Machine Learning Pipeline

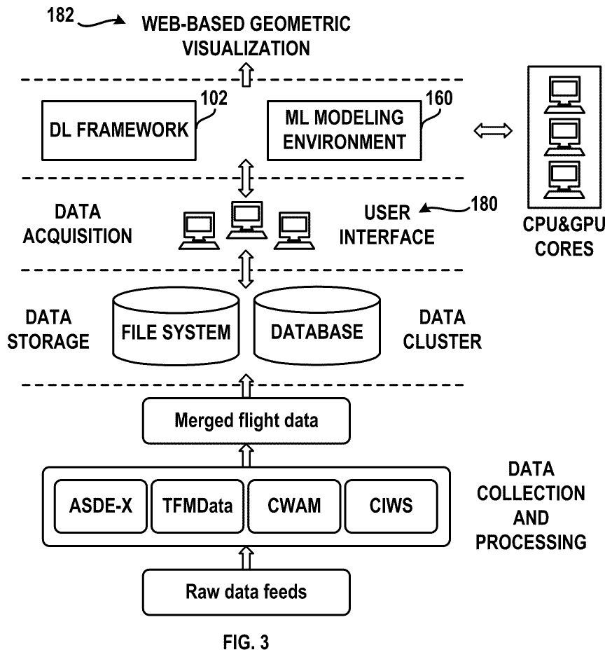

A machine learning problem-solving pipeline for the uncertainty-aware near-terminal multi-aircraft TP task that implements aspects of the system 100 is shown in FIG. 3; in particular, FIG. 3 shows schematic representations and technical stacks. The lower level of the pipeline shows how the raw radar recording data is collected, processed, and stored in SDW, where data integration is adopted to handle data heterogeneity.

The system 100 includes a The pipeline includes a user interface 180 that enables a user to acquire the data desired for the research. The raw data can be used to construct the input graph 116 166 as discussed herein, which incorporates Haversine distances between agents represented within the input graph. The system 100 implements the deep-learning framework 102 (B-STAR) with an object-oriented programming language and large-scale data processing tools. With the help of multiple CPU & GPU cores, the system 100 performs parallelized training of the deep-learning framework 102 for rapid inference on the demonstration case. On the system output layer, web-based interactive visualization tools (e.g., visual representation generator 182) are adopted for the geometrical representation of predictions provided by the deep-learning framework 102 (B-STAR) of the system 100.

### 4.3.3. Visualization of Test Results

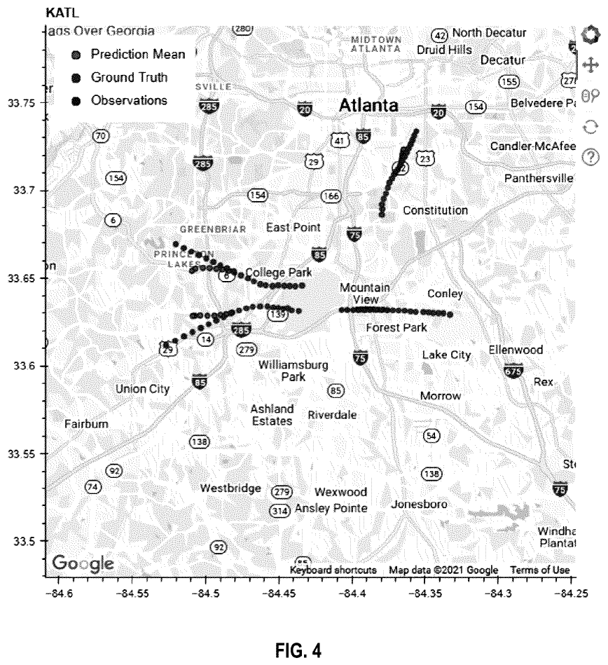

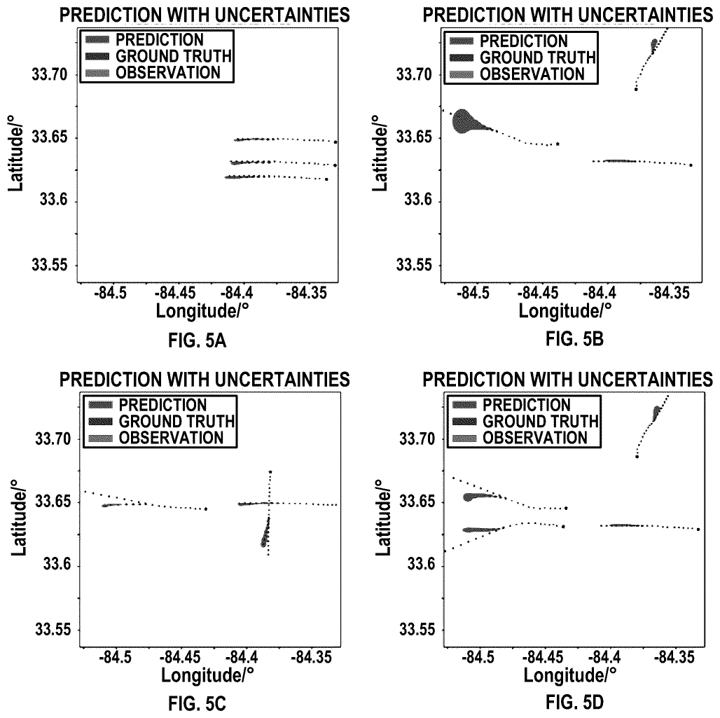

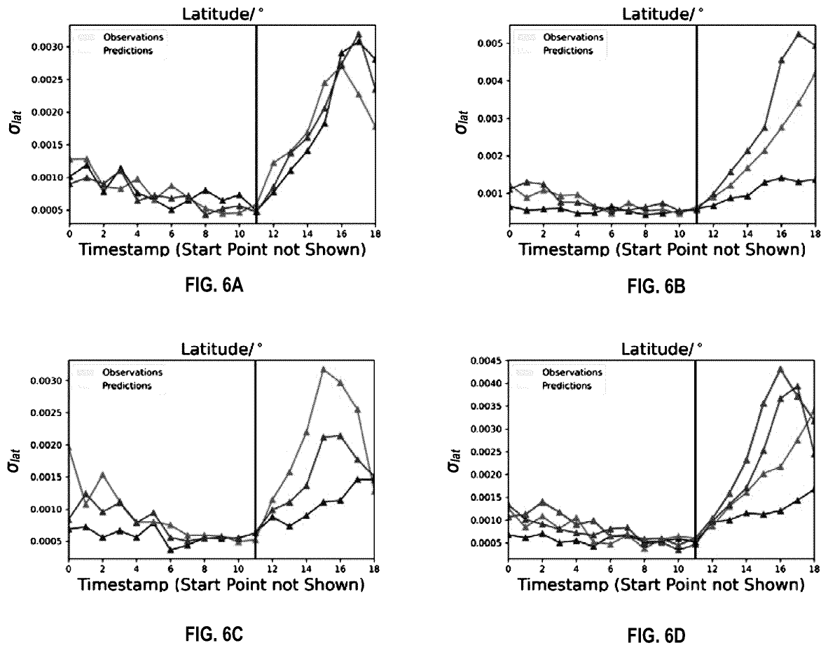

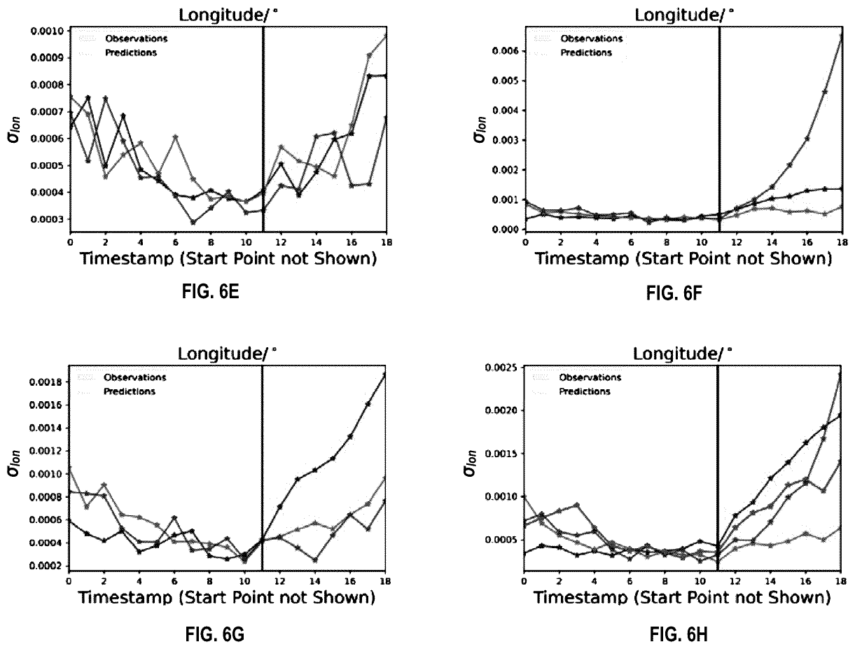

FIGS. 4 and 5A-5D present the prediction on the test dataset. Also, FIGS. 6A-6H show the uncertainty values corresponding with both the observation timestamps and the prediction timestamps. FIG. 4, visualizes one sample from the model output that belongs to the test dataset. To achieve this, the neighbor indices are first determined by plotting the adjacency matrix A of TGConv. Based on A, the correct neighbors indices can be found and matched with the observations, predictions, and ground truth tracks. Additional coordinate shifting and rotating are performed.

FIG. 5A shows that the deep-learning framework 102 (B-STAR) of the system 100 can predict temporal consistent trajectories, where three aircraft are heading towards the airport in parallel. The uncertainty of these three aircraft in FIGS. 6A and 6E is also small, given that they follow the same parallel pattern without possible intersection. In FIG. 5B, the model of the system 100 predicts the aircraft moving direction successfully but with slightly delayed locations. However, it was found that the uncertainty value for the prediction also increases with a longer prediction horizon. In FIGS. 5C and 5D, two cases are presented where the moving direction is not correctly predicted. The typical case is departing aircraft fails at making a good prediction. It is a common pattern that the prediction uncertainty on the latitude dimension has a sudden drop in FIGS. 6A-6H. This is due to the FDE constraint on trajectory sequences. Also, the runway of KATL has an east-west layout, which has minimal changes in the latitude dimension. This explains no similar pattern in the longitude dimension.

Generally, the system 100 shows a significant predicting capability on the landing aircraft sequence but could see improvement for predictions on departing aircraft. As shown in FIG. 2, the departing aircraft has multiple flight routes. On the contrary, the landing sequence is much simpler, while the aircraft are lined-up. The task of improving the prediction power for more complicated departing aircraft cases is reserved as a major future study, which will be discussed in Section 5.

### 4.3.4. Sensitivity Study

To better understand the prediction capability and provide sufficient guidance for applying the machine learning model in the real case, the sensitivity study on the two parameters of B-STAR is conducted as follows:
Prediction-Observation Ratio (PO-ratio) θ: The ratio between the prediction horizon and the observation horizon. A larger PO-ratio stands for longer prediction power with less observed data.
Graph Neighboring Threshold ξ: The separation distance threshold to determine if the connection between two aircraft was established.

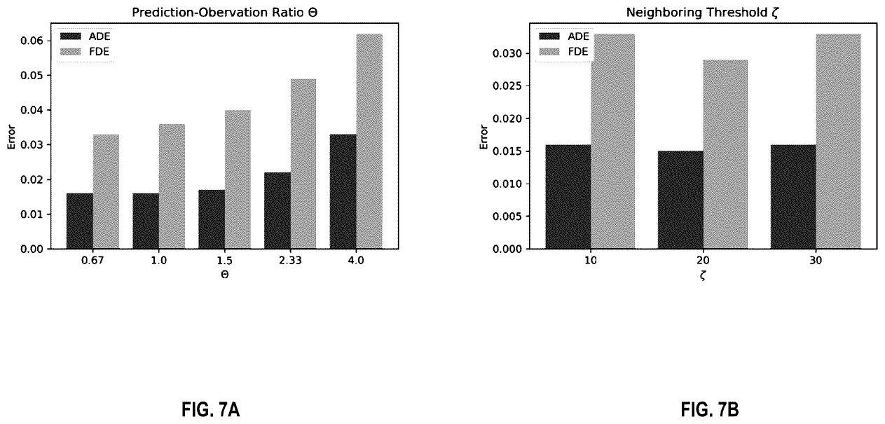

The sensitivity study is performed by retraining the model, with different parameters in the preprocessing stage. It is obvious that in FIG. 7A, the ADE and FDE increase with the enlargement of PO-Ratio. It is expected to have a larger error with a longer prediction horizon. Also notice that the ADE has a minor increase at θ=0.67, 1.0, 1.5. FIG. 7B shows the error when altering the graph neighboring threshold (10, 20, 30 in kilometers, corresponding to approximately 5, 10, 15 nautical miles). Notice that there is not a significant change in the error metrics. The reason is ASDE-X data only covers a small range of flight tracks, (=10 km already covers all the aircraft in the airspace. In such a case, increasing makes no difference to the neighboring graph.

### 5. Discussions

This work shows that the uncertainty-aware TP model can leverage the spatial and temporal coherence between multiple agents in the scenario. The model of the system 100 interactively forecasts the future location of multiple agents with a user-defined prediction time interval based on the current observations. The model of the system 100 can handle an arbitrary number of agents shown in the current map. The uncertainty of the prediction increases with an elongated prediction horizon. This section mainly discusses the limitations in Section 5.1 and insights in Section 5.2 from the air transportation aspects.

### 5.1. Limitations

There are several limitations of the existing methods. Firstly, the construction of the graph data requires a minimum distance threshold to fill the adjacency matrix. The threshold value is an assumption on the potential impact between nearby aircraft.

Based on the aeronautical separation standards, ξ=10 km is used as the threshold, where the tower believes two aircraft with a distance closer than ξ=10 km will have interactions.

Further validation on the best ξ is valuable. Also, this work does not consider the operation on the altitude dimension. This is based on the assumption that the near-terminal aircraft is generally at a low altitude where a vertical separation is not critical, as the cases of surveillance radar are being simulated. Lastly, the time interval of the down-sampled data is actually the prediction time interval. In real applications, to achieve real-time forecasting, the execution time of the model should be smaller than the prediction interval. Δt=5 s is being used for this purpose. In the deployment phase, the model inference time for forecasting the next location of the current scenario is 2.74 s. If using classmate enforcing, the prediction-response time for the controller/pilot will be 2.26 s. However, in the current experiment setup, the ground truth is not being fed into the model prediction in real-time, and the total inference time for the entire 8 prediction timestamps is 21.66 s. The corresponding response time for the pilot/controller will be 18.34 s, which is acceptable in real-world practices.

### 5.2 Insights

This work is beneficial for the future development of safety-critical autonomous system applications, e.g., an accurate uncertainty-aware TP contributes to an early collision warning system. Probabilistic risk assessment is based on uncertainty quantification from the training data. Based on the limitations:
The demonstration of the model of the system 100 can be improved in many aspects. A further accuracy improvement is expected upon inclusion of orientations, airspeed, and altitude dimension. In such a way, the approach outlined herein is suitable for predicting trajectories in the enlarged airspace rather than the low-altitude, near-terminal region.
The sensitive study on neighboring threshold can be further improved using the data from larger airspace. The current ASDE-X data has limited coverage around the airport control tower compared to the data from an air traffic control center (ARTCC).
Future work combined with transfer learning and domain adaptation is desired to increase the generalizability of the framework. For instance, the system 100 can be trained with the flight data from one airport and adapted to get an accurate prediction on the flight data from another airport using domain adaption methods, where different controllers' preferences existed. Also, the prediction power can be transferred from commercial aircraft to other airborne agents, such as helicopters and drones, with the help of domain generation methods
Due to the characteristics of Bayesian deep learning, the execution time of the model for online, multi-aircraft trajectory forecasting is impacted by the sampling procedure during the test phase. From an algorithm-development aspect, a model compression technique can be beneficial for reducing the computational cost, where knowledge distillation is a feasible direction to look into. From the engineering perspective, both software and hardware upgrades are available. TensorRT with C++ will significantly reduce the inference time. Hardware such as NVIDIA Orin will boost the performance by a wide margin.

### 6. Conclusions

This disclosure presents a graph-structured Transformer-based deep neural network architecture for the uncertainty-aware multi-agent trajectory prediction task. It is shown that uncertainty-aware prediction can be achieved with a particular Bayesian formulation to the trajectory prediction deep learning network. The model is demonstrated and validated using the commonly used standard pedestrian TP dataset (ETH and UCY) and a near-terminal aircraft TP dataset from Sherlock. The predictions of the system 100 are analyzed individually and statistically, with a sensitivity study to further understand the prediction power. The several cases are visualized on the geographical map around the ASDE-X data range of KATL. Following this, the sensitivity studies focused on the PO-ratio θ and the neighboring threshold ξ. These studies show the optimal future prediction horizon w.r.t. the observation horizon. One unique focus of the study is on the impact of different aviation regulation encodings on air traffic predictions.

### 7. Method

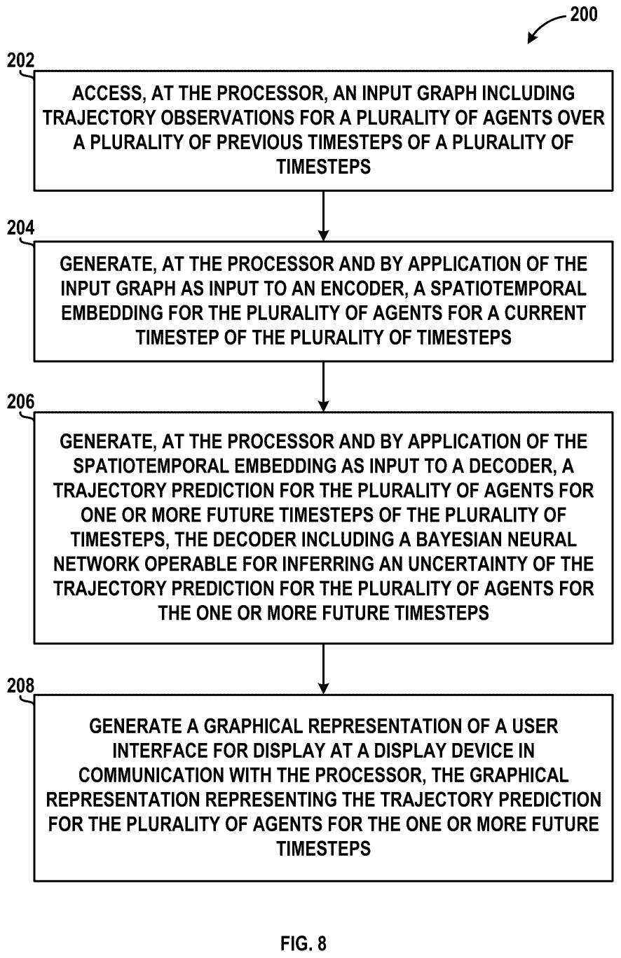

FIG. 8 shows a method 200 for predicting vehicle trajectories using the system 100.

Step 202 of method 200 includes accessing, at the processor, an input graph including trajectory observations for a plurality of agents over a plurality of previous timesteps of a plurality of timesteps. Step 202 can also include constructing the input graph including trajectory observations for the plurality of agents over the plurality of previous timesteps of the plurality of timesteps. The input graph incorporates a Haversine distance between a first agent and a second agent of the plurality of agents for one or more timesteps of the plurality of timesteps, the first agent being a first aircraft and the second agent being a second aircraft.

Step 204 of method 200 includes generating, at the processor and by application of the input graph as input to an encoder, a spatiotemporal embedding for the plurality of agents for a current timestep of the plurality of timesteps. Step 204 can also include generating a preliminary spatiotemporal embedding for the input graph at a parallel stage of the encoder and for a current timestep of the plurality of timesteps and generating the spatiotemporal embedding for the input graph at a sequential stage of the encoder based on the preliminary spatiotemporal embedding and for the current timestep of the plurality of timesteps. At the parallel stage, the method includes: generating, by a first temporal transformer of the parallel stage of the encoder, a first updated temporal embedding for the input graph; generating, by a first spatial transformer of the parallel stage of the encoder, a first updated spatial embedding for the input graph; and generating the preliminary spatiotemporal embedding by combination of the first updated temporal embedding and the first updated spatial embedding at a multilayer perceptron of the encoder. At the sequential stage of the encoder, the method includes: generating, by application of the preliminary spatiotemporal embedding as input to a second temporal transformer of the sequential stage of the encoder, a second updated temporal embedding; generating, by application of the second updated temporal embedding as input to a second spatial transformer of the sequential stage of the encoder, the spatiotemporal embedding for the input graph; and applying the second updated temporal embedding to the first temporal transformer of the parallel stage of the encoder through the graph memory.

Step 206 of method 200 includes generating, at the processor and by application of the spatiotemporal embedding as input to a decoder, a trajectory prediction for the plurality of agents for one or more future timesteps of the plurality of timesteps, the decoder including a Bayesian neural network operable for inferring an uncertainty of the trajectory prediction for the plurality of agents for the one or more future timesteps. The Bayesian neural network can be trained by: accessing, at the processor, a training set including an input sequence and an output sequence that corresponds with the input sequence; inferring, at the processor, a posterior probability distribution of a set of parameters of the Bayesian neural network based on the input sequence and the output sequence of the training set; and sampling, at the processor and based on the posterior probability distribution of the set of parameters, parameter values of the set of parameters of the Bayesian neural network.

Step 208 of method 200 includes generating a graphical representation of a user interface for display at a display device in communication with the processor, the graphical representation representing the trajectory prediction for the plurality of agents for the one or more future timesteps.

### 8. Computer-Implemented System

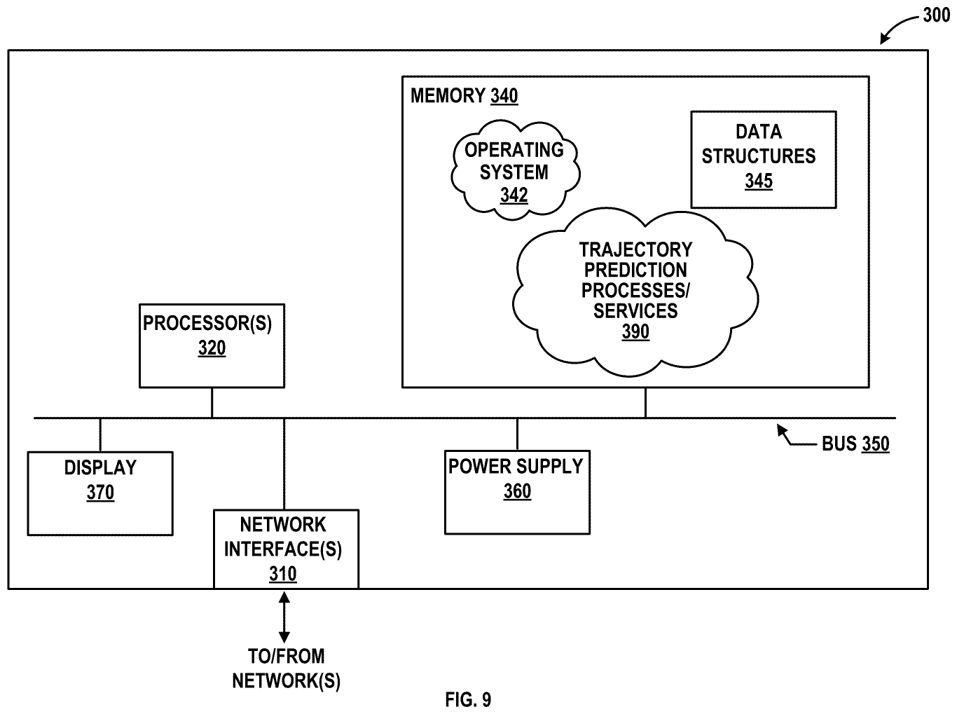

FIG. 9 is a schematic block diagram of an example device 300 that may be used with one or more embodiments described herein, e.g., implementing aspects of the system 100 and/or the method 200.

Device 300 comprises one or more network interfaces 310 (e.g., wired, wireless, PLC, etc.), at least one processor 320, and a memory 340 interconnected by a system bus 350, as well as a power supply 360 (e.g., battery, plug-in, etc.). Device 300 can further include one or more display device(s) 370 in communication with the processor 320.

Network interface(s) 310 include the mechanical, electrical, and signaling circuitry for communicating data over the communication links coupled to a communication network. Network interfaces 310 are configured to transmit and/or receive data using a variety of different communication protocols. As illustrated, the box representing network interfaces 310 is shown for simplicity, and it is appreciated that such interfaces may represent different types of network connections such as wireless and wired (physical) connections. Network interfaces 310 are shown separately from power supply 360, however it is appreciated that the interfaces that support PLC protocols may communicate through power supply 360 and/or may be an integral component coupled to power supply 360.

Memory 340 includes a plurality of storage locations that are addressable by processor 320 and network interfaces 310 for storing software programs and data structures associated with the embodiments described herein. In some embodiments, device 300 may have limited memory or no memory (e.g., no memory for storage other than for programs/processes operating on the device and associated caches). Memory 340 can include instructions executable by the processor 320 that, when executed by the processor 320, cause the processor 320 to implement aspects of the system 100 and the method 200 outlined herein. The memory 340 can be a non-transitory computer-readable medium. In some embodiments the computer-readable storage devices, mediums, and memories can include a cable or wireless signal including a bit stream and the like. However, when mentioned, non-transitory computer-readable storage media expressly exclude media such as energy, carrier signals, electromagnetic waves, and signals per se.

Processor 320 comprises hardware elements or logic adapted to execute the software programs (e.g., instructions) and manipulate data structures 345. An operating system 342, portions of which are typically resident in memory 340 and executed by the processor, functionally organizes device 300 by, inter alia, invoking operations in support of software processes and/or services executing on the device. These software processes and/or services may include trajectory prediction processes/services 390, which can include aspects of method 200 and/or implementations of various modules described herein. Note that while trajectory prediction processes/services 390 is illustrated in centralized memory 340, alternative embodiments provide for the process to be operated within the network interfaces 310, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the trajectory prediction processes/services 390 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

1. A system, comprising:
a processor in communication with a memory, the memory including instructions executable by the processor to:
access, at the processor, an input graph including trajectory observations for a plurality of agents over a plurality of previous timesteps of a plurality of timesteps;
generate, at the processor and by application of the input graph as input to an encoder, a spatiotemporal embedding for the plurality of agents for a current timestep of the plurality of timesteps; and
generate, at the processor and by application of the spatiotemporal embedding as input to a decoder, a trajectory prediction for the plurality of agents for one or more future timesteps of the plurality of timesteps, the decoder including a Bayesian Neural Network operable for inferring an uncertainty of the trajectory prediction for the plurality of agents for the one or more future timesteps.

2. The system of claim 1, the Bayesian Neural Network of the decoder being trained by a processor in communication with a memory including instructions executable by the processor to:
access, at the processor, a training set including an input sequence and an output sequence that corresponds with the input sequence;
infer, at the processor, a posterior probability distribution of a set of parameters of the Bayesian Neural Network based on the input sequence and the output sequence of the training set; and
sample, at the processor and based on the posterior probability distribution of the set of parameters, parameter values of the set of parameters of the Bayesian Neural Network.

3. The system of claim 2, inference of the posterior probability distribution of the set of parameters of the Bayesian Neural Network including application of a variational inference technique based on variational free energy.

4. The system of claim 1, the Bayesian Neural Network of the decoder including an output layer, the output layer being deterministic.

5. The system of claim 1, the memory further including instructions executable by the processor to:
construct the input graph including trajectory observations for the plurality of agents over the plurality of previous timesteps of the plurality of timesteps, the input graph incorporating a Haversine distance between a first agent and a second agent of the plurality of agents for one or more timesteps of the plurality of timesteps, the first agent being a first aircraft and the second agent being a second aircraft.

6. The system of claim 1, the memory further including instructions executable by the processor to:
generate a preliminary spatiotemporal embedding for the input graph at a parallel stage of the encoder and for a current timestep of the plurality of timesteps; and
generate the spatiotemporal embedding for the input graph at a sequential stage of the encoder based on the preliminary spatiotemporal embedding and for the current timestep of the plurality of timesteps.

7. The system of claim 6, the memory further including instructions executable by the processor to:
generate, by a first temporal transformer of the parallel stage of the encoder, a first updated temporal embedding for the input graph;
generate, by a first spatial transformer of the parallel stage of the encoder, a first updated spatial embedding for the input graph; and
generate the preliminary spatiotemporal embedding by combination of the first updated temporal embedding and the first updated spatial embedding at a multilayer perceptron of the encoder.

8. The system of claim 6, the memory further including instructions executable by the processor to:
generate, by application of the preliminary spatiotemporal embedding as input to a second temporal transformer of the sequential stage of the encoder, a second updated temporal embedding; and
generate, by application of the second updated temporal embedding as input to a second spatial transformer of the sequential stage of the encoder, the spatiotemporal embedding for the input graph.

9. The system of claim 8, the parallel stage of the encoder including a first temporal transformer in communication with a graph memory, and the memory further including instructions executable by the processor to:
apply the second updated temporal embedding to the first temporal transformer of the parallel stage of the encoder through the graph memory.

10. The system of claim 1, the memory further including instructions executable by the processor to:
generate a graphical representation of a user interface for display at a display device in communication with the processor, the graphical representation representing the trajectory prediction for the plurality of agents for the one or more future timesteps.

11. A method, comprising:
accessing, at a processor in communication with a memory, an input graph including trajectory observations for a plurality of agents over a plurality of previous timesteps of a plurality of timesteps;
generating, at the processor and by application of the input graph as input to an encoder, a spatiotemporal embedding for the plurality of agents for a current timestep of the plurality of timesteps; and
generating, at the processor and by application of the spatiotemporal embedding as input to a decoder, a trajectory prediction for the plurality of agents for one or more future timesteps of the plurality of timesteps, the decoder including a Bayesian Neural Network operable for inferring an uncertainty of the trajectory prediction for the plurality of agents for the one or more future timesteps.

12. The method of claim 11, the Bayesian Neural Network of the decoder being trained by steps including:
accessing, at a processor in communication with a memory for training the Bayesian Neural Network of the decoder, a training set including an input sequence and an output sequence that corresponds with the input sequence;
inferring, at the processor, a posterior probability distribution of a set of parameters of the Bayesian Neural Network of the decoder based on the input sequence and the output sequence of the training set; and
sampling, at the processor and based on the posterior probability distribution of the set of parameters, parameter values of the set of parameters of the Bayesian Neural Network.

13. The method of claim 12, the step of inferring the posterior probability distribution of the set of parameters of the Bayesian Neural Network including application of a variational inference technique based on variational free energy.

14. The method of claim 11, further comprising:
constructing the input graph including trajectory observations for the plurality of agents over a plurality of previous timesteps of the plurality of timesteps, the input graph incorporating a Haversine distance between a first agent and a second agent of the plurality of agents for one or more timesteps of the plurality of timesteps, the first agent being a first aircraft and the second agent being a second aircraft.

15. The method of claim 11, further comprising:
generating a preliminary spatiotemporal embedding for the input graph at a parallel stage of the encoder and for a current timestep of the plurality of timesteps; and
generating the spatiotemporal embedding for the input graph at a sequential stage of the encoder based on the preliminary spatiotemporal embedding and for the current timestep of the plurality of timesteps.

16. The method of claim 15, further comprising:
generating, by a first temporal transformer of the parallel stage of the encoder, a first updated temporal embedding for the input graph;
generating, by a first spatial transformer of the parallel stage of the encoder, a first updated spatial embedding for the input graph; and
generating the preliminary spatiotemporal embedding by combination of the first updated temporal embedding and the first updated spatial embedding at a multilayer perceptron of the encoder.

17. The method of claim 15, further comprising:
generating, by application of the preliminary spatiotemporal embedding as input to a second temporal transformer of the sequential stage of the encoder, a second updated temporal embedding; and
generating, by application of the second updated temporal embedding as input to a second spatial transformer of the sequential stage of the encoder, the spatiotemporal embedding for the input graph.

18. The method of claim 17, the parallel stage of the encoder including a first temporal transformer in communication with a graph memory, and the method further comprising:
applying the second updated temporal embedding to the first temporal transformer of the parallel stage of the encoder through the graph memory.

19. The method of claim 11, the method further comprising:
generating a graphical representation of a user interface for display at a display device in communication with the processor, the graphical representation representing the trajectory prediction for the plurality of agents for the one or more future timesteps.

20. A non-transitory computer readable medium having instructions encoded thereon executable by a processor to:
access, at the processor, an input graph including trajectory observations for a plurality of agents over a plurality of previous timesteps of a plurality of timesteps;
generate, at the processor and by application of the input graph as input to an encoder, a spatiotemporal embedding for the plurality of agents for a current timestep of the plurality of timesteps; and
generate, at the processor and by application of the spatiotemporal embedding as input to a decoder, a trajectory prediction for the plurality of agents for one or more future timesteps of the plurality of timesteps, the decoder including a Bayesian Neural Network operable for inferring an uncertainty of the trajectory prediction for the plurality of agents for the one or more future timesteps.
